(19) United States
(12) Patent Application Publication
(10) Pub. No.: US 2017/0329939 A1
(43) Pub. Date: Nov. 16, 2017

(54) INFORMATION PROCESSING APPARATUS, PROGRAMMABLE DEVICE, LICENSE MANAGEMENT SYSTEM, AND LICENSE MANAGEMENT METHOD

(71) Applicant: CANON KABUSHIKI KAISHA, Tokyo (JP)

(72) Inventor: Naoto Yuki, Kawasaki-shi (JP)

(21) Appl. No.: 15/492,048

(22) Filed: Apr. 20, 2017

(30) Foreign Application Priority Data
May 13, 2016 (JP) 2016-097389

(51) Int. Cl. G06F 21/10; G06F 9/445; G06Q 20/12

(52) U.S. Cl. CPC G06F 21/105; G06Q 20/127; G06F 8/61; G06F 2221/0768

(57) ABSTRACT

In addition to an update license related to a contract period of an application, a license server issues an installation license for configuring the application and an extension installation license. When an image forming apparatus has received the installation license from the license server, the application can be used as long as the current date is within a usage period for carrying out the configuration task. If the current date is past that period, a license is acquired from the license server. The acquired license is an update license in the case where the update license is valid, and is an extension installation license in other cases.

### BACKGROUND OF THE INVENTION

### Field of the Invention

The present invention relates to license management techniques.

### Description of the Related Art

An image forming apparatus typically has basic functions such as copying, printing, and scanning as standard features, with extended functions available as options. Normally, a user who wishes to use an extended function will purchase a product that provides the desired extended function. Some such extended function products use a subscription-based model, where paying a usage fee at the time of purchase allows the user to use the function only for the period of a corresponding contract. For example, Japanese Patent No. 5454102 discloses a technique in which a license for extending the period of a contract to use an extended function is applied to an image forming apparatus upon it being confirmed that a usage fee has been paid. A customer can then use the extended function during the period for which s/he paid the usage fee.

Initial setup tasks are sometimes carried out for image forming apparatuses in advance, so that a customer can use the apparatus immediately after taking delivery thereof. Such initial setup tasks include installing extended functions, setting configuration values thereof, testing whether or not the function actually works, and so on. However, according to the invention disclosed in Japanese Patent No. 5454102, an extended function can only be used from the date on which the customer entered into the contract. Thus the initial setup tasks of installing and configuring the extended function, which are to be carried out before the contract period, cannot be carried out.

### SUMMARY OF THE INVENTION

The present invention makes it possible to carry out advance tasks, for which a license is normally required, even before a contract has been made with a customer.

The present invention has the following configuration. That is, according to a first aspect of the present invention, there is provided an information processing apparatus comprising: a first issuance unit configured to issue an installation license, having a predetermined validity period, for installing a program in a device, and sends the installation license to the device in response to a request from the device; a second issuance unit configured to issue and save, for the device, an extension installation license that extends the validity period of the installation license by a set period, in response to an extension request; and a license updating unit configured to send the extension installation license to the device in response to a license update request from the device.

According to a second aspect of the present invention, there is provided a programmable device capable of executing a program for which a license has been received, the device comprising: an acquisition unit configured to acquire, from an information processing apparatus functioning as a license server, an installation license, having a predetermined validity period, for installing a program in the device; a sending unit configured to send a license update request to the information processing apparatus; and a receiving unit configured to receive, from the information processing apparatus, an extension installation license that extends the validity period of the installation license by a set period, as a response to the license update request, wherein the sending unit sends the license update request in the case where the validity period of the installation license has ended.

According to a third aspect of the present invention, there is provided a license management system comprising an information processing apparatus and a programmable device capable of executing a program for which a license has been received, the information processing apparatus including: a first issuance unit configured to issue an installation license, having a predetermined validity period, for installing a program in a device, and sends the installation license to the device in response to a request from the device; a second issuance unit configured to issue and save, for the device, an extension installation license that extends the validity period of the installation license by a set period, in response to an extension request; and a license updating unit configured to send the extension installation license to the device in response to a license update request from the device, and the programmable device including: an acquisition unit configured to acquire, from an information processing apparatus functioning as a license server, an installation license, having a predetermined validity period, for installing a program in the device; a sending unit configured to send a license update request to the information processing apparatus; and a receiving unit configured to receive, from the information processing apparatus, an extension installation license that extends the validity period of the installation license by a set period, as a response to the license update request, wherein the sending unit sends the license update request in the case where the validity period of the installation license has ended.

According to the present invention, tasks requiring a license can be carried out even before a contract has been made with a customer.

Further features of the present invention will become apparent from the following description of exemplary embodiments with reference to the attached drawings.

### BRIEF DESCRIPTION OF THE DRAWINGS

FIG. 1 is a diagram illustrating a network configuration.

FIGS. 2A and 2B are diagrams illustrating a hardware configuration.

FIGS. 3A and 3B are diagrams illustrating a software configuration.

FIG. 4 is a diagram illustrating an example of a screen provided by an image forming apparatus.

FIG. 5 is a diagram illustrating an example of a screen provided by a license server.

FIGS. 6A, 6B, 6C, and 6D are diagrams illustrating the data structures of files.

FIGS. 7A and 7B are diagrams illustrating an example of a usable period of an application in the image forming apparatus.

FIG. 8 is a flowchart illustrating processing executed by an extension application receiving unit.

FIG. 9 is a flowchart illustrating processing executed by a license update request receiving unit.

FIG. 10 is a flowchart illustrating processing executed by an extension application deletion unit.

FIG. 11 is a sequence chart illustrating a sequence from the acquisition to the extension of an installation license.

### DESCRIPTION OF THE EMBODIMENTS

Hereinafter, embodiments of the present invention will be described with reference to the drawings. First, terms used herein will be defined.

### Definitions

An “application file” is a file holding a program (an application program) providing an extended function of the image forming apparatus. An application file is not included as a standard feature of the image forming apparatus. Rather, the application file is received by the image forming apparatus along with a license (described later) in response to an installation request during initial setup, and is stored in a hard disk of the image forming apparatus. A license (described later) is required to install and use an application file.

A “license” is a file required in order to permit an application file to be installed in an image forming apparatus or permit an application file to be used. There are two types of licenses, namely an installation license and an update license. The installation license is a license permitting an application file to be installed in the image forming apparatus and used in a limited manner for a specific number of days (or a specific period) before the start of a contract. Furthermore, there are two types of installation licenses, namely an installation license for initial setup, and an extension installation license for extending the period. The installation license is an installation license enabling installation in any image forming apparatus before the start of the contract. The extension installation license is an installation license that, in the case where a task has not been completed within a specific number of days for which the installation license can be used, extends the license by a different specified number of days (or for a set period). Depending on the license, the specific period for which the application can be used is also called a “usable period” or “validity period” of the license. As such, being within the period for which the license can be used is also referred to as “being within the validity period”.

The update license is a license permitting the application file to be installed and the application file to be used within the contract period.

System Configuration

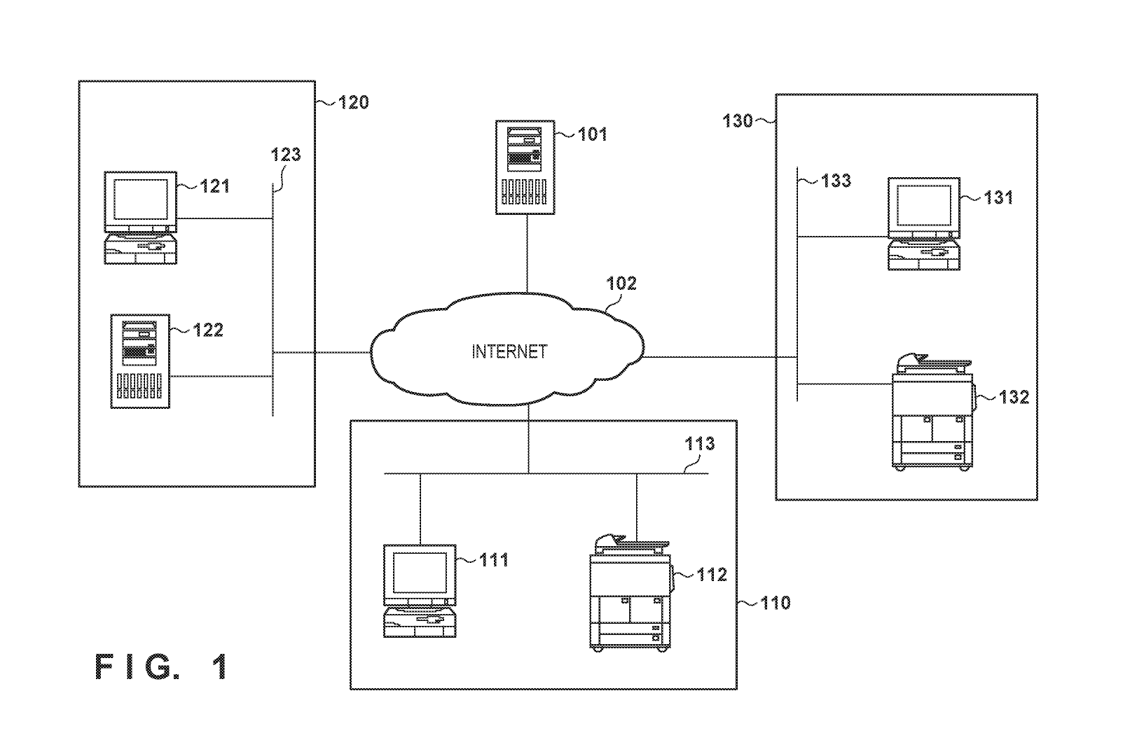

FIG. 1 illustrates a network configuration of a license management system according to the present embodiment. A license server 101 is a server that can issue a license and can communicate with various apparatuses over the internet 102. In the example illustrated in FIG. 1, image forming apparatuses 112 and 132 and information processing apparatuses 111, 121, and 131 are depicted as being individually connected to networks, several of these apparatuses may be connected to a network together instead. The image forming apparatuses 112 and 132 are examples of programmable devices that can install and execute an aftermarket program for which a license has been accepted.

A customer network environment 110 is a network environment of a customer who has purchased the image forming apparatus 112. In the customer network environment 110, the image forming apparatus 112 and the information processing apparatus 111 are connected over a local area network (LAN) 113. The LAN 113 is connectable to the internet 102. A sales company network environment 120 is a network environment of a sales company that sells the extended function. In the sales company network environment 120, the information processing apparatus 121 and a contract server 122 are connected through a LAN 123. The LAN 123 can connect to the internet 102. A setup site network environment 130 is a network environment of a setup site where the initial setup of the image forming apparatus 132 is to be carried out. In the setup site network environment 130, the information processing apparatus 131 and the image forming apparatus 132 for which the initial setup is to be carried out are connected through a LAN 133. The LAN 133 can connect to the internet 102. The image forming apparatus 132 is delivered to the customer from the setup site after the initial setup tasks are complete, whereupon the image forming apparatus 132 is connected to the customer network environment 110 and used as the image forming apparatus 112. An aftermarket application can be installed in the image forming apparatus. A license issued from the license server 101 is needed to use the installed application, and the license is installed in the image forming apparatus in the same manner as the application. Applications meeting conditions specified by the installed license (for example, corresponding applications, validity periods, and so on) can then be used.

Hardware Configuration

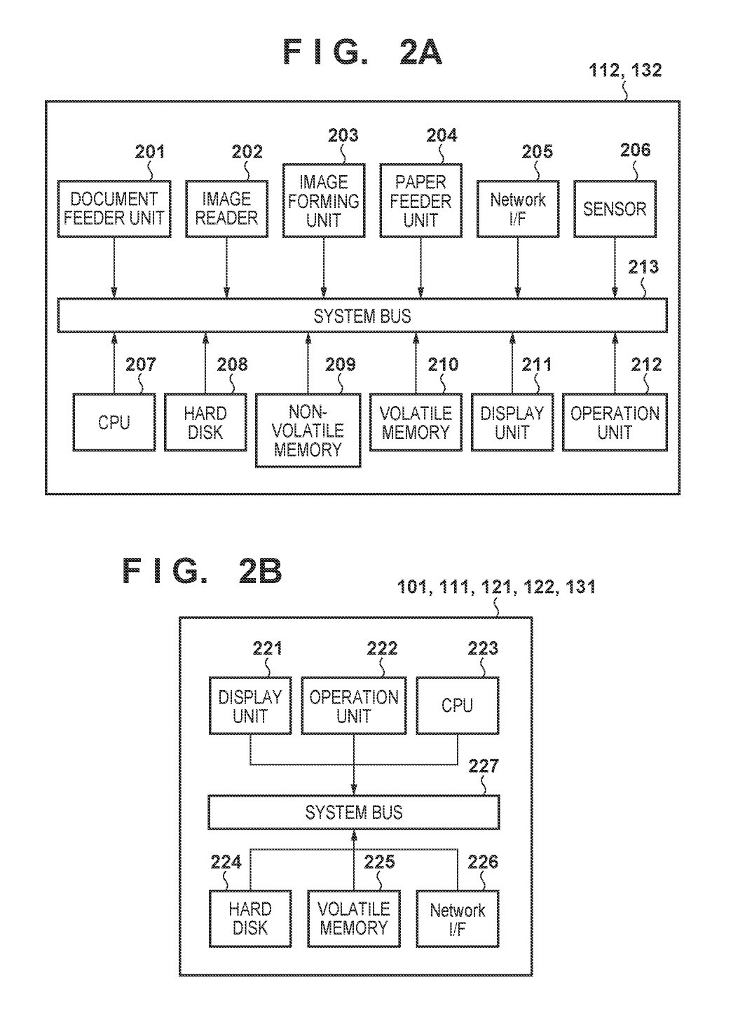

FIGS. 2A and 2B illustrate a hardware configuration of the license management system according to the present embodiment. FIG. 2A illustrates the hardware configurations of the image forming apparatuses 112 and 132, whereas FIG. 2B illustrates the hardware configurations of the information processing apparatuses 111, 121, and 131, the contract server 122, and the license server 101.

As illustrated in FIG. 2A, the image forming apparatuses 112 and 132 have the following configuration. A document feeder unit 201 automatically feeds a document to be read to an image reader 202. The image reader 202 (a scanner, for example) optically reads the document fed thereto and outputs image data. An image forming unit 203 converts the image data of the read document and received data into a print image, and prints the print image. A paper feeder unit 204 feeds paper used for printing. A network interface (I/F) 205 connects to the LANs 113 and 133 and the internet 102 to exchange information with the exterior. A sensor 206 detects states of various parts of the image forming apparatus. A CPU 207 executes programs and controls various processes performed by the image forming apparatus. A hard disk 208 stores programs and data relating to the processes performed by the image forming apparatus. A non-volatile memory 209 is a rewritable memory that can store information without power being supplied thereto, and is a Ferroelectric Random Access Memory (FRAM) (trade name), for example. A volatile memory 210 is a rewritable memory that can electrically store temporary data relating to the processes performed by the image forming apparatus. A display unit 211 displays information relating to an operational state of the image forming apparatus and information relating to operations input via an operation unit 212. The operation unit 212 receives instructions input to the image forming apparatus. A system bus 213 connects the units 201-212 to each other and delivers data among those units.

As illustrated in FIG. 2B, the information processing apparatuses 111, 121, and 131, the contract server 122, and the license server 101 have the following configuration. A display unit 221 displays windows, icons, messages, menus, and other user interface information. An operation unit 222 receives inputs from an end user who uses a keyboard or a mouse. A CPU 223 executes programs and controls various processes performed by the image forming apparatus. A hard disk 224 stores programs and data relating to the processes performed by the image forming apparatus. A volatile memory 225 is a rewritable memory that can electrically store temporary data relating to the processes performed by the information forming apparatus. A network interface (I/F) 226 connects to the LANs 113, 123, and 133 and the internet 102 to exchange information with the exterior. A system bus 227 connects the units 221-226 to each other and delivers data among those units.

License Server Software Configuration

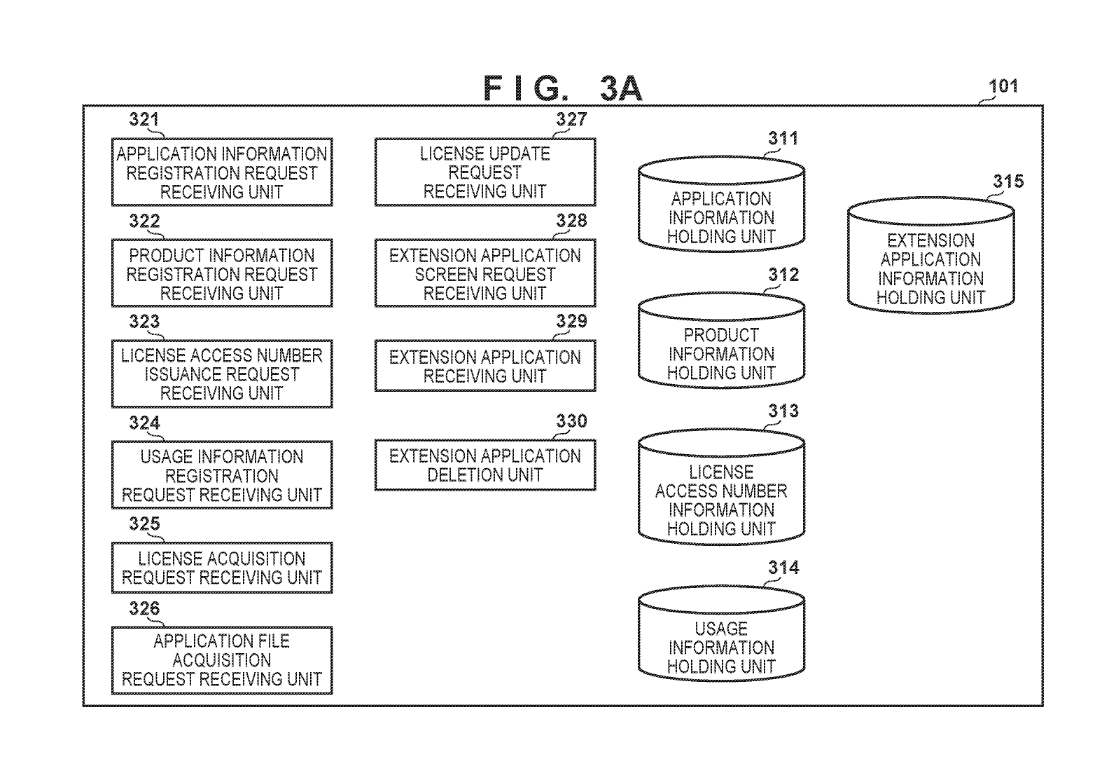

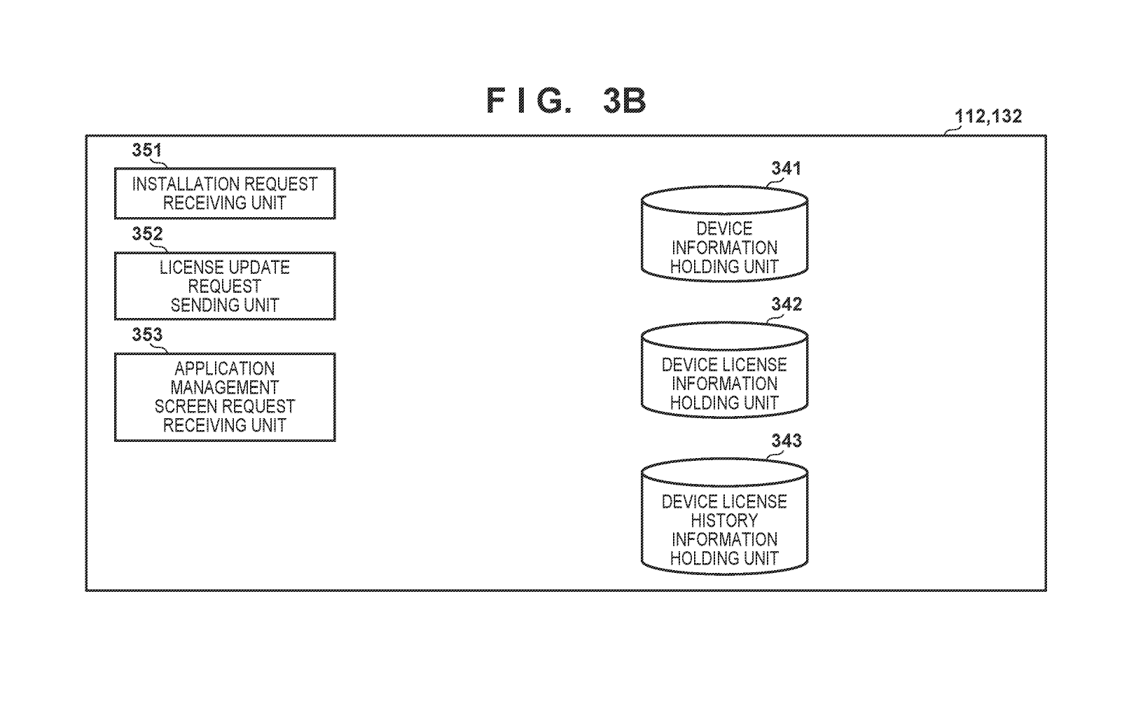

FIGS. 3A and 3B illustrate a software configuration of the license management system according to the present embodiment. FIG. 3A is a diagram illustrating the software configuration of the license server 101, and FIG. 3B is a diagram illustrating the software configuration of the image forming apparatuses 112 and 132.

Each software module in the license server 101 illustrated in FIG. 3A functions as a result of the CPU 223 of the license server 101 loading a program stored in the hard disk 224 into the volatile memory 225 and executing that program.

Application Information Table

An application information holding unit 311 holds an application information table in the hard disk 224 of the license server 101. Table 1 indicates an example of the application information table held in the application information holding unit 311. “Application” is abbreviated as “app” in the table. The same applies to the other tables as well.

TABLE 1
Application Information Table

| App ID | App Version | App Name | File Path |
|---|---|---|---|
| app001 | 3.0 | Anyplace | /apps/anyplace_3.0.jar |
| | | Print | |
| app002 | 2.1 | SEITON Fax | /apps/seiton_2.1.jar |
| app003 | 1.3 | My Choice | /apps/myprint_1.3.jar |
| | | Printing | |

In the application information table indicated in Table 1, the “application ID” column is a column that holds an application ID, which is an identifier uniquely identifying the type of the application file. The “application version” column is a column that holds the version of the application file. An application file can be uniquely identified based on the application ID and the application version. The “application name” column is a column that holds an application name. The “file path” column is a column that holds the path where each application file is located. Each record in the application information table is referred to as an “application information record”, which is registered in the table on an application-by-application basis. An application information record is added as a result of an application information registration request receiving unit 321 receiving an application information registration request, which will be described later.

Product Information Table

A product information holding unit 312 holds a product information table, which itself holds product information, in the hard disk 224 of the license server 101. A “product” is a unit by which an application file is sold, and a customer purchases products in units of the product information. Table 2 indicates an example of the product information table held in the product information holding unit 312. These products are, for example, applications installed in the image forming apparatus 112 or the like.

TABLE 2
Product Information Table

| Product ID | Product Name | App ID |
|---|---|---|
| P0002 | Anyplace Print | app001 |
| P0004 | SEITON Fax | app002 |
| P0006 | VNC | app003 |

In the product information table indicated in Table 2, the “product ID” column is a column that holds a product ID, which is an identifier that uniquely identifies a product. The “product name” column is a column that holds a product name. The “application ID” column is a column that holds the application ID of an application file that can be used once the product has been purchased. Each record stored in the product information table is referred to as a “product information record” and is registered in the table on a product-by-product basis. A product information record is added as a result of a product information registration request receiving unit 322 receiving a product information registration request, which will be described later. Although the present embodiment describes an example in which a single piece of product information is associated with a single piece of application information, a single piece of product information may instead be associated with multiple pieces of application information. In such a case, purchasing a single product enables a customer to use the application files corresponding to the associated multiple pieces of application information.

License Access Number Information Table

A license access number information holding unit 313 holds a license access number information table, which itself holds license access number information, in the hard disk 224 of the license server 101. A “license access number” is data or information required in order to acquire an application file and a license from the license server 101 over the internet 102. Table 3 indicates an example of the license access number information table held in the license access number information holding unit 313.

TABLE 3
License Access Number Information Table

| License | | | |
|---|---|---|---|
| Access Number | Product ID | License ID | File Path |
| LA01 | P0002 | LF00001 | /lic/LF00001.lic |
| LA02 | P0004 | LF00007 | /lic/LF00007.lic |
| LA03 | P0006 | LF00004 | /lic/LF00004.lic |

In the license access number information table indicated in Table 3, the “license access number” column is a column that holds the license access number. The “product ID” column is a column that holds the product ID of the product that can be used with the license access number. The “license ID” column is a column that holds the license ID of an installation license for initial setup, which is generated when the license access number is issued. The license IDs held in the license ID column are all unique values for those licenses. The “file path” column is a column that holds the path where the installation license generated when the license access number is issued is located.

Each record in the license access number information table is called a “license access number information record”, and a license access number information record is added each time a license access number is issued by a license access number issuance request receiving unit 323, which will be described later. A single license access number and a single installation license are issued for a corresponding single product.

Usage Information Table

A usage information holding unit 314 holds a usage information table, which itself holds usage information, in the hard disk 224 of the license server 101. The “usage information” is information of a contract entered into by a customer and a sales company, and is information indicating for what period the purchasing customer is permitted to use the product with the image forming apparatus. Table 4 indicates an example of the usage information table held in the usage information holding unit 314.

TABLE 4
Usage Information Table

| License | Device | Use | Use | | |
|---|---|---|---|---|---|
| Access | Serial | Start | End | | |
| Number | Number | Date | Date | License ID | File Path |
| LA01 | AAA00130 | Sep. 1, 2015 | Dec. 31, 2015 | LF00009 | /lic/LF00009.lic |
| LA02 | AAA00130 | Sep. 1, 2015 | Dec. 31, 2015 | LF00020 | /lic/LF00020.lic |
| LA03 | AAA00130 | Sep. 1, 2015 | Dec. 31, 2015 | LF00027 | /lic/LF00027.lic |

In the usage information table indicated in Table 4, the “license access number” column is a column that holds the license access number of the product for which the customer entered into the contract. The “device serial number” column is a column that holds a device serial number of the image forming apparatus in which the product for which the customer entered into a contract, for example an application, is installed. The “use start date” column is a column that holds a start date of the period of the contract into which the customer entered. The “use end date” column is a column that holds an end date of the period of the contract into which the customer entered. Note that the use start date and the use end date are expressed as year/month/day, for example. The “license ID” column is a column that holds the license ID of an update license generated when the usage information is registered. The license IDs held in the license ID column are all unique values for those licenses. The “file path” column is a column that holds the path where the update license generated when the usage information is registered is located. Each record in the usage information table is called a “usage information record”, and a usage information record is added each time usage information is registered by a usage information registration request receiving unit 324, which will be described later. Table 4 indicates an example in which the sales company and the customer have entered into contracts for products indicated by license access numbers LA01, LA02, and LA03, for a period from Sep. 1, 2015 to Dec. 31, 2015, for an image forming apparatus having a device serial number of AAA00130, which was purchased by the customer.

Extension Application Information Table

An extension application information holding unit 315 holds an extension application information table, which itself holds extension application information, in the hard disk 224 of the license server 101. Table 5 indicates an example of the extension application information table held in the extension application information holding unit 315. Note that a period extension application is also called a “period extension request”.

TABLE 5
Extension Application Information Table

| License | Device | | | |
|---|---|---|---|---|
| Access | Serial | | License | |
| Number | Number | Status | ID | File Path |
| LA02 | AAA00130 | Already | LF00030 | /lic/LF00030.lic |
| | | acquired | | |
| LA03 | AAA00130 | Not yet | LF00037 | /lic/LF00037.lic |
| | | acquired | | |

In the extension application information table indicated in Table 5, the “license access number” column is a column that holds a license access number specified in the period extension application. The “device serial number” column is a column that holds a device serial number specified in the period extension application. The “status” column is a column that holds the status of the corresponding extension application information record. “Not yet acquired” is held when a period extension application has been made but an extension installation license has not been installed in the image forming apparatus for that period extension application, whereas “already acquired” is held when the extension installation license for that period extension application has been installed in the image forming apparatus. “Delete” is set for a period extension application that is no longer needed.

The “license ID” column is a column that holds the license ID of an extension installation license generated during the period extension application. The license IDs held in the license ID column are all unique values for those licenses. The “file path” column is a column that holds the path where the extension installation license generated during the period extension application is located. Each record in the extension application information table is called an “extension application information record”, and an extension application information record is added each time a period extension application is received by an extension application receiving unit 329, which will be described later.

Application Information Registration Request Receiving Unit 321

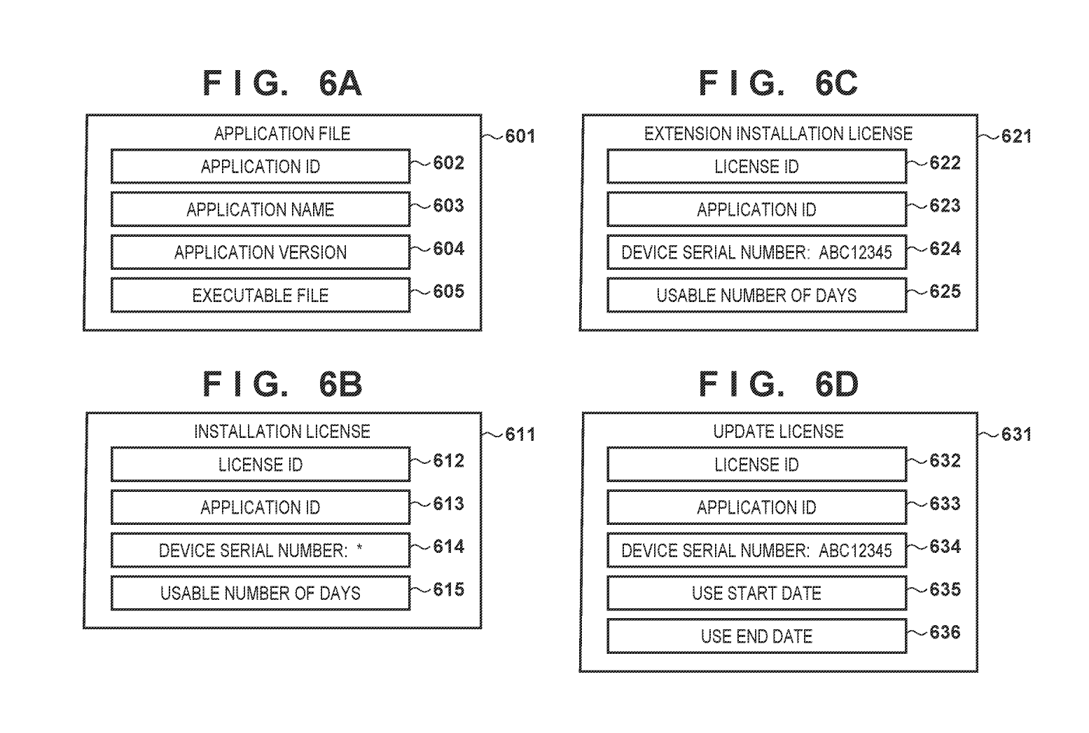

The application information registration request receiving unit 321 receives the application information registration request from the network I/F 226 provided in the license server 101, and executes processing in response thereto. The application information registration request is sent from the information processing apparatus 121 of the sales company. The application information registration request receiving unit 321 acquires an application file 601 (see FIG. 6A) from the received application information registration request, and stores that file in the hard disk 224. The application information registration request receiving unit 321 also acquires an application ID 602, an application name 603, and an application version 604 from the stored application file 601. The file path of the stored application file 601, and the application ID 602, the application name 603, and application version 604 that have been acquired, are added to the application information table as a new application information record.

Product Information Registration Request Receiving Unit 322

The product information registration request receiving unit 322 receives the product information registration request from the network I/F 226 provided in the license server 101, and executes processing in response thereto. The product information registration request is sent from the information processing apparatus 121 of the sales company. The product information registration request includes at least a product ID, a product name, a product type, and an application ID. The product information registration request receiving unit 322 adds data acquired from the received product information registration request to the product information table as a new product information record. Although Table 2 does not include the “product type” column, the column may be included.

License Access Number Issuance Request Receiving Unit 323

The license access number issuance request receiving unit 323 receives a license access number issuance request from the network I/F 226 provided in the license server 101, and executes processing in response thereto. The license access number issuance request is sent from the information processing apparatus 121 of the sales company. The license access number issuance request includes at least a product ID. The license access number issuance request receiving unit 323 issues a license access number and an installation license for initial setup 611 (see FIG. 6B) for the product having the product ID included in the acquired license access number issuance request, and returns those items as a response. Note that it is possible to return only the issued license access number to the requesting information processing apparatus, or the license server 101 may hold the issued installation license without the installation license being sent to the requesting information processing apparatus. Because the installation license 611 is also issued in response to the license access number issuance request, the license access number issuance request can also be called an “installation license issuance request”. The issued installation license is passed to the image forming apparatus in response to a license acquisition request from the image forming apparatus, and is installed in the image forming apparatus.

A unique identifier is set in a license ID 612 of the issued installation license 611, whereas the application ID of the product having the product ID included in the license access number issuance request is set in an application ID 613. A “*”, which indicates that the license can be installed in any image forming apparatus, is set in a device serial number 614, and “5”, indicating that the license is valid for a predetermined period corresponding to five days, for example, from the date of installation, is set in a usable number of days 615. Although the usable number of days 615 is fixed at 5 in the present embodiment, the usable number of days may be included in the license access number issuance request so as to be variable.

The license access number issuance request receiving unit 323 creates the license access number information record containing the information of the received product ID, the issued license access number, and the installation license (including the license ID and the file path, for example), and adds that record to the license access number information table.

The issued installation license is returned to the information processing apparatus 121 as a response to the license access number issuance request. Furthermore, when a license acquisition request receiving unit 325 and a license update request receiving unit 327, which will be described later, receive a request from the image forming apparatus, those units return the installation license to the requesting image forming apparatus as a response.

Usage Information Registration Request Receiving Unit 324

The usage information registration request receiving unit 324 receives a usage information registration request from the network I/F 226 provided in the license server 101, and executes processing in response thereto. The usage information registration request is sent from the information processing apparatus 121 of the sales company, the contract server 122, or the like. The usage information registration request includes at least a license access number, a device serial number, a use start date, and a use end date. The usage information registration request receiving unit 324 issues a update license on the basis of the information included in the acquired usage information registration request. A unique identifier is set in a license ID 632 of an update license 631 that is issued (see FIG. 6D), and a product application ID specified by the license access number included in the usage information registration request is set in an application ID 633. The device serial number, use start date, and use end date included in the usage information registration request are set in a device serial number 634, a use start date 635, and a use end date 636, respectively. The usage information registration request receiving unit 324 creates a usage information record including the received information of the license access number, the device serial number, the use start date, the use end date, and the issued update license, and adds that record to the usage information table. When the license acquisition request receiving unit 325 and the license update request receiving unit 327, which will be described later, receive a request from the image forming apparatus, those units return the issued update license to the requesting image forming apparatus as a response.

License Acquisition Request Receiving Unit 325

The license acquisition request receiving unit 325 receives the license acquisition request from the network I/F 226 provided in the license server 101, and executes processing in response thereto. The license acquisition request includes a license access number and a device serial number. The license acquisition request receiving unit 325 returns a license based on the acquired license access number and device serial number as a response. Specifically, the license acquisition request receiving unit 325 checks, or in other words, determines whether a usage information record that matches the license access number and the device serial number included in the received license acquisition request is present. If such a usage information record is present, the license acquisition request receiving unit 325 checks whether the values of the use start date and the use end date included in the usage information record meet the following condition: use start date≦current date≦use end date. Here, the formula X≦Y indicates that Y is the same date as X or that Y is a later date than X. In other words, it is determined whether there is an update license, specified by the license access number and the device serial number, that is currently valid. In the case where the aforementioned condition is met, the update license in the file path included in the usage information record is returned as a response. However, in the case where no such usage information record is present, the aforementioned condition is not met, or the like, the installation license located at the file path of the license access number information record that matches the acquired license access number is returned as a response.

Thus as described above, the license acquisition request receiving unit 325 returns the update license as a response in the case where there is usage information indicating that the image forming apparatus is in the usable period, and returns the installation license as a response in all other cases. If no license file is located in the file path, there is no license to be returned, and thus a response indicating this is returned.

Application File Acquisition Request Receiving Unit 326

An application file acquisition request receiving unit 326 receives an application file acquisition request from the network I/F 226 provided in the license server 101, and executes processing in response thereto. The application file acquisition request includes a license access number. The application file acquisition request receiving unit 326 returns the application file related to the license access number included in the acquired application file acquisition request as a response.

Specifically, the application file acquisition request receiving unit 326 acquires the license access number from the acquired application file acquisition request. Next, the application file acquisition request receiving unit 326 acquires the license access number information record matching the acquired license access number from the license access number information table indicated in Table 3. Next, the application file acquisition request receiving unit 326 acquires the product information record matching the product ID in the acquired license access number information record from the product information table indicated in Table 2. Next, the application file acquisition request receiving unit 326 acquires the application ID from the acquired product information record. Next, the application file acquisition request receiving unit 326 acquires the application information record that matches the acquired application ID from the application information table in Table 1. The application file acquisition request receiving unit 326 then returns the application file 601 in the file path included in the acquired application information record as a response. Note that the file path of an application can also be acquired from the license access number by constructing a single database from the tables indicated in Tables 1 to 5, for example. In other words, although the items indicated in Tables 1 to 5 are registered in separate tables, it is also possible to associate items that are the same throughout the tables with each other.

License Update Request Receiving Unit 327

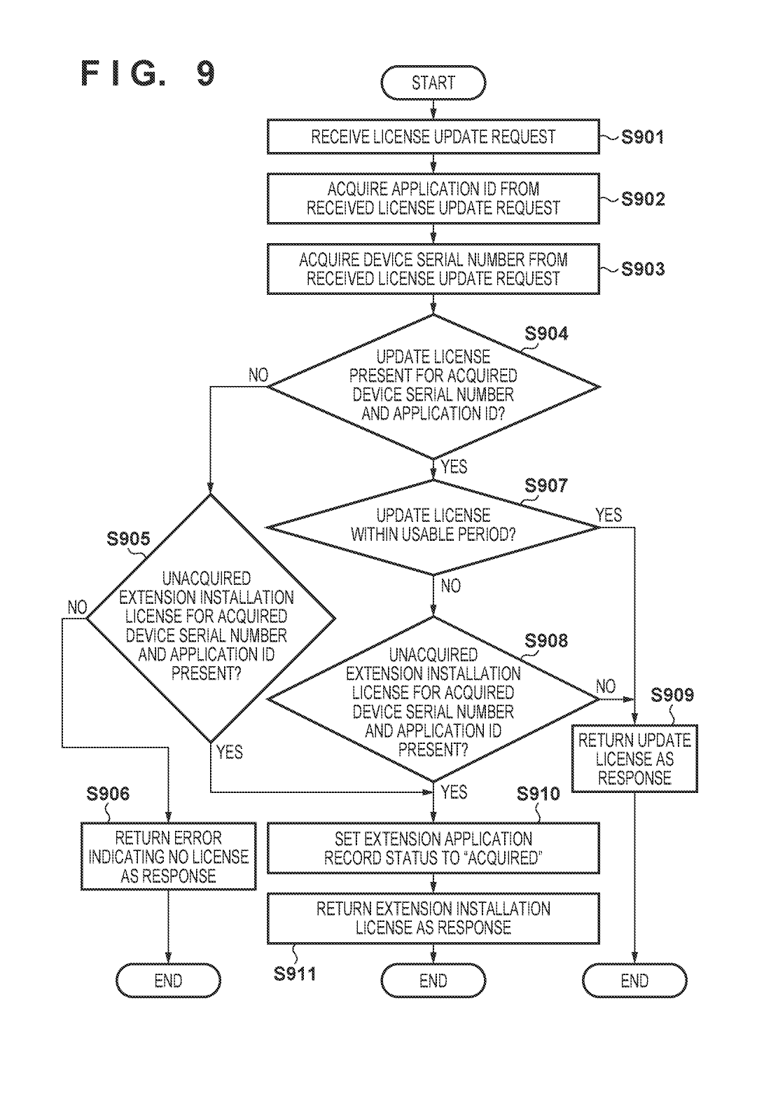

The license update request receiving unit 327 receives a license update request from the network I/F 226 provided in the license server 101, and executes processing in response thereto. The license update request includes a device serial number and the application ID of the application file 601 for which an update license is to be acquired. In the case where there is usage information indicating a usable period for the acquired device serial number and application ID, the license update request receiving unit 327 returns an update license as a response, whereas in the case where there is no usage information indicating such a usable period but there is period extension application information, the license update request receiving unit 327 returns an extension installation license as a response. The processing performed by the license update request receiving unit 327 will be described in detail later with reference to the flowchart in FIG. 9.

Extension Application Screen Request Receiving Unit 328

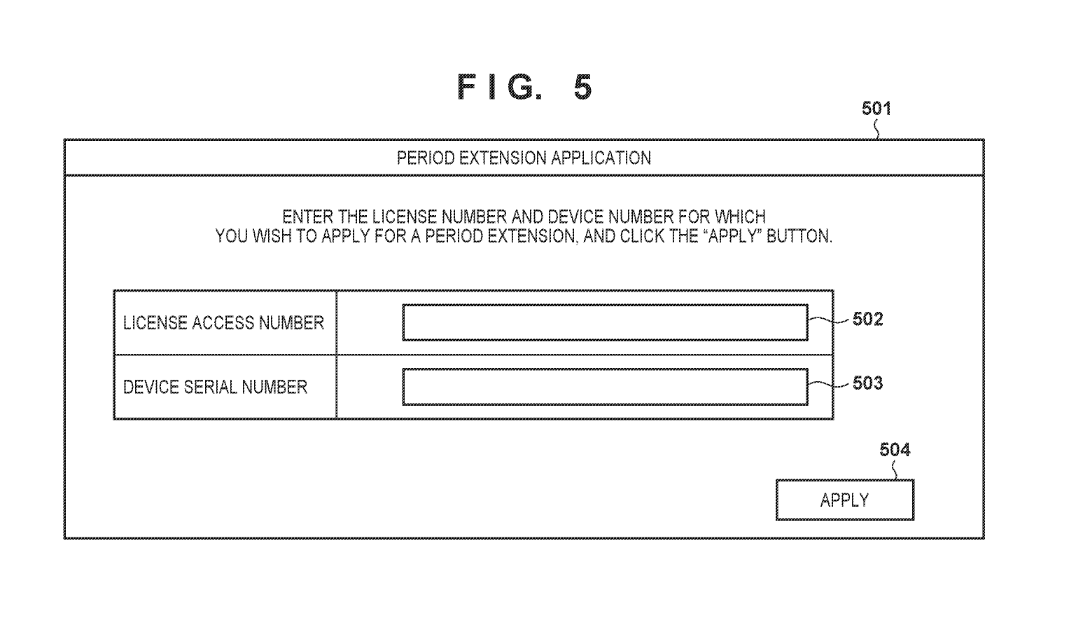

An extension application screen request receiving unit 328 receives an extension application screen request from the network I/F 226 provided in the license server 101, and executes processing in response thereto. The extension application screen request is a request to display a period extension application screen for applying to extend the validity period of the installation license, and is sent from the information processing apparatus 121 of the sales company. The extension application screen request receiving unit 328 sends data for displaying a period extension application screen 501 (described later; see FIG. 5) to the requesting information processing apparatus 121.

Extension Application Receiving Unit 329

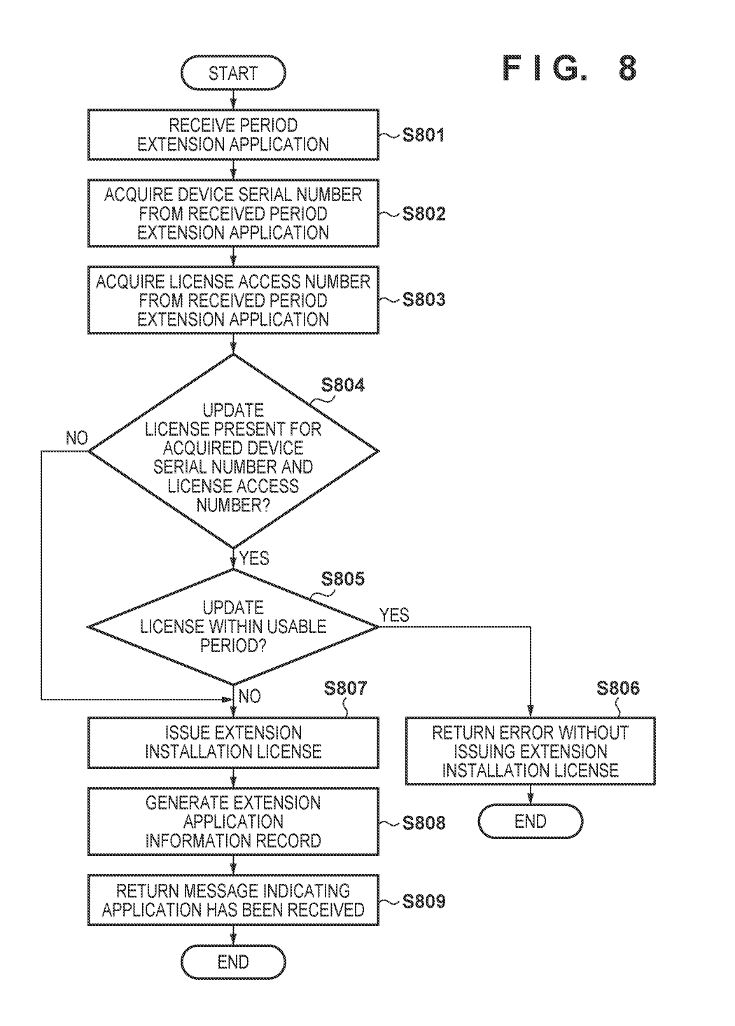

The extension application receiving unit 329 receives the period extension application from the network I/F 226 provided in the license server 101, and executes processing in response thereto. The period extension application includes the license access number of the product for which the period is to be extended, and the device serial number of the image forming apparatus. The extension application receiving unit 329 issues an extension installation license that extends the period by a predetermined amount (a specific number of days, for example) for the device serial number from which the period extension application was received. The issued extension installation license is returned to the license update request receiving unit 327 from the image forming apparatus as a response to the request. The processing performed by the extension application receiving unit 329 will be described in detail later with reference to the flowchart in FIG. 8.

An extension application deletion unit 330 is a unit executed in batch processing when the license server 101 is started up each day.

The extension application deletion unit 330 deletes the extension application information record created by the extension application receiving unit 329 in the case where the usable period of the update license is reached without a license update request from the image forming apparatus.

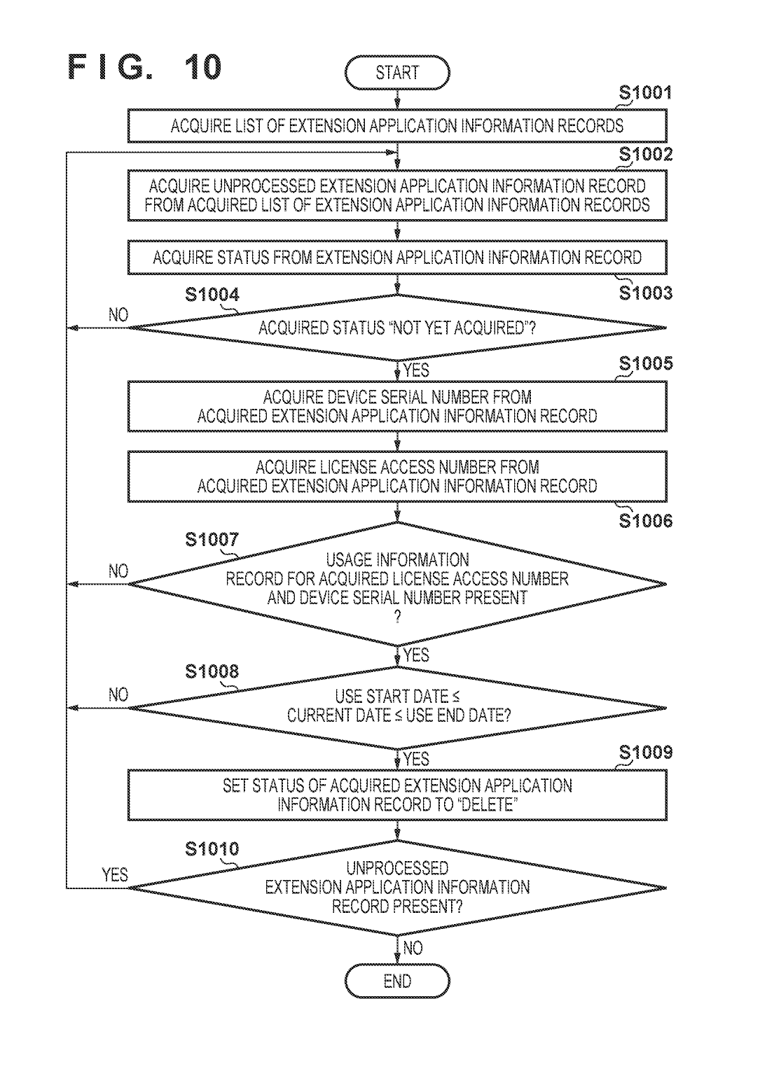

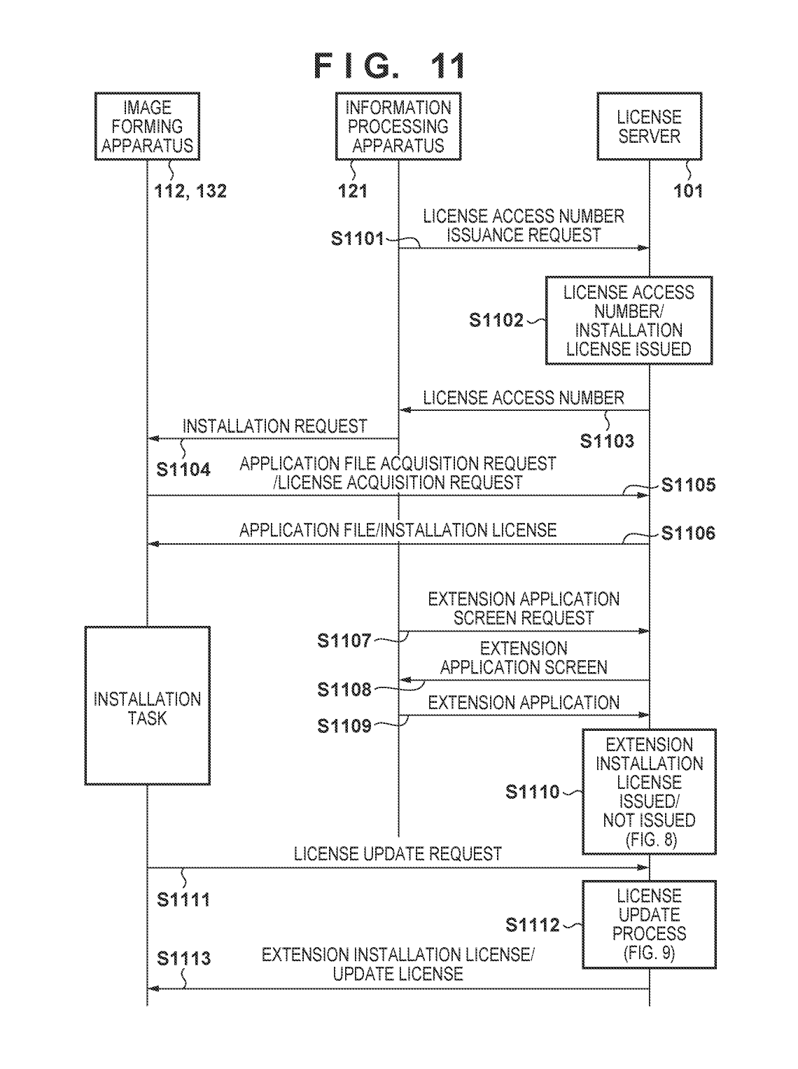

The processing performed by the extension application deletion unit 330 will be described in detail later with reference to the flowchart in FIG. 10.

Software Configuration of Image Forming Apparatus

The various units in the software configuration illustrated in FIG. 3B are executed by the CPU 207 of the image forming apparatuses 112 and 132 loading programs stored in the hard disk 208 into the volatile memory 210.

Device Information Table

A device information holding unit 341 is a unit that holds a device information table in the hard disk 208 of the image forming apparatuses 112 and 132. The device information table holds at least a device serial number that uniquely identifies the image forming apparatuses 112 and 132 that have that device information table.

Device License Information Table

A device license information holding unit 342 is a unit that holds a device license information table in the hard disk 208 of the image forming apparatuses 112 and 132. Table 6 indicates an example of the device license information table held in the device license information holding unit 342.

TABLE 6
Device License Information Table

| App | App | App | Use Start | Use End | |
|---|---|---|---|---|---|
| ID | Version | Name | Date | Date | File Path |
| app001 | 3.0 | Anyplace | | Sep. 29, 2015 | /apps/anyplace_3.0.jar |
| | | Print | | | |
| app002 | 2.1 | SEITON | | Sep. 29, 2015 | /apps/seiton_2.1.jar |
| | | Fax | | | |
| app003 | 1.3 | My | | Sep. 29, 2015 | /apps/myprint_1.3.jar |
| | | Choice | | | |
| | | Printing | | | |

In the device license information table indicated in Table 6, the “application ID” column is a column that holds the application ID 602 of the installed application file 601. The “application version” column is a column that holds the application version 604 of that application file. The “application name” column is a column that holds the application name 603 of that application file. The “use start date” column is a column that holds a date at which that application file can start being used, and the date is expressed as year/month/day, for example. The “use end date” column is a column that holds the date on which the usage of that application file is to end. The “file path” column is a column that holds the path where the application file is located in the hard disk 208 of the image forming apparatuses 112 and 132.

The image forming apparatus determines whether or not the application file can be used on the basis of the information stored in the device license information table. It is determined that the application file can be used in the case where the values of the use start date and the use end date meet the following condition: use start date≦current date≦use end date. Note that the formula X≦Y indicates that Y is the same date as X or that Y is a later date than X. If only the value of the use end date is available, it is determined that the application file can be used in the case where the following condition is met: current date≦use end date.

Each record of the device license information table is called a “device license information record”, and a device license information record is added each time an application file is installed using a license.

Device License History Information Table

A device license history information holding unit 343 is a unit that holds a device license history information table in the hard disk 208 of the image forming apparatuses 112 and 132. Table 7 indicates an example of the device license history information table held in the device license history information holding unit 343.

TABLE 7
Device License History Information Table

| License ID | Application ID |
|---|---|
| LF00001 | app001 |
| LF00007 | app002 |
| LF00009 | app003 |

In the device license history information table indicated in Table 7, the “license ID” column is a column that holds the license ID of the license used in the installation. The “application ID” column is a column that holds the application ID for that license. Each record of the device license history information table is called a “device license history information record”, and a device license history information record is added each time an application file is installed using a license. The device license history information table is used in order to prevent the period of a license from being extended using a license having a license ID used in the past.

Installation Request Receiving Unit 351

An installation request receiving unit 351 receives an installation request from the network I/F 205 of the image forming apparatus, and executes processing in response thereto. The installation request is sent from the information processing apparatus. The installation request includes a license access number. This license access number is issued by the license server 101 along with an installation license in response to the license access number issuance request sent to the license server 101 by the information processing apparatus.

The installation request receiving unit 351 sends, to the license server 101, the application file acquisition request, which includes the license access number included in the received installation request and a device serial number held in the device information holding unit 341, as well as the license acquisition request.

The installation request receiving unit 351 carries out an installation determination process for the application file, using the application file and the license returned in response to the application file acquisition request and the license acquisition request that have been sent. The installation request receiving unit 351 determines that the application can be installed in the case where the following three conditions are met. The first condition is that the application ID included in the acquired license matches the application ID of the application file. The second is that the device serial number of the acquired license matches a device serial number held in the device information holding unit 341 or is a wild card. The case where the device serial number of the license is a wild card can also be considered a case where the device serial numbers match. The third is that the license ID of the acquired license is not present in the device license history information table indicated in Table 7. In the case where these three conditions are met, the installation request receiving unit 351 determines that the application file can be installed, and adds a device license information record to the device license information table on the basis of the acquired application file and license information. In the case where the acquired license is an installation license, a use start date and a use end date are not assigned to the license, and thus a date obtained by adding the usable number of days 615 to the current date, for example, is registered as the use end date. Although the use start date need not be registered, the current date may be registered as the use start date. Furthermore, a device license history information record is added to the device license history information table on the basis of the application ID and license ID for the acquired license. Specifically, a device license history information record including the application ID and license ID for the acquired license is added.

License Update Request Sending Unit 352

A license update request sending unit 352 sends a license update request to the license server. The license update request sending unit 352 is executed in the case where the use end date of a record held in the device license information table is earlier than the current date, or in other words, in the case where the validity period of the license has ended, the case where a server-directed license confirmation button 406 has been pressed in an application management screen 401, or the like. Whether the validity period of the license has ended can be determined by checking the device license information table periodically, for example once a day.

When the license update request sending unit 352 is executed, the application ID of a record, in the device license information table, in which the use end date<the current date, or of a record for which the license confirmation button 406 was pressed, is acquired. Note that the formula X<Y indicates that Y is later than X. Furthermore, the license update request sending unit 352 acquires the device serial number held in the device information holding unit 341. Next, the license update request sending unit 352 sends a license update request including the acquired application ID and device serial number. The license update request sending unit 352 acquires the license sent as a response, and updates the use start date and use end date in the device license information record using that license. The application ID and license ID for the acquired license are also added to the device license history information record.

Application Management Screen Request Receiving Unit 353

An application management screen request receiving unit 353 receives an application management screen request from the network I/F 205 of the image forming apparatus, and executes processing in response thereto. The application management screen request is sent from the information processing apparatus. The application management screen request receiving unit 353 sends data for displaying the application management screen 401, which will be described later, to the requesting information processing apparatus. The application management screen request receiving unit 353 may be executed upon the application management screen request from the operation unit 212 of the image forming apparatus being received, and may send data for displaying the application management screen 401 in the display unit 211 of the image forming apparatus. The application management screen request from the operation unit 212 of the image forming apparatus is issued, for example, as a result of a user selecting a predetermined item from a displayed menu, such as pressing an application management screen display button.

Application Management Screen

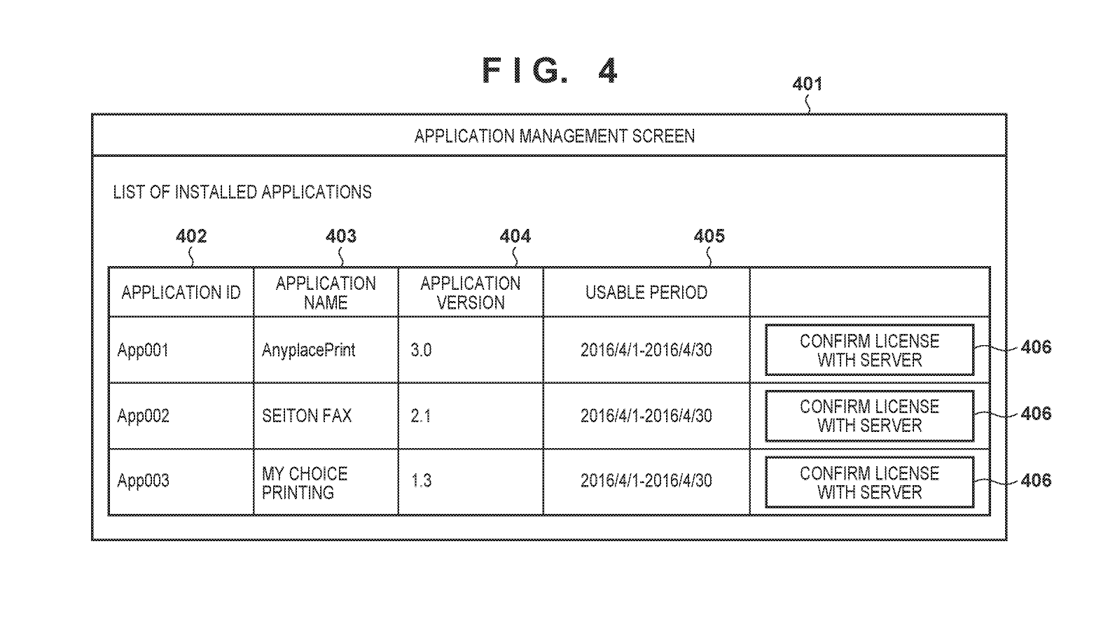

FIG. 4 illustrates an example of the application management screen provided by the image forming apparatuses 112 and 132 through the application management screen request receiving unit 353 and displayed by the information processing apparatus or the image forming apparatus. The application management screen 401 is a screen that displays information of installed application files, license files, and so on, and is used for updating licenses. The application management screen 401 is returned as a response from the image forming apparatuses 112 and 132 in the case where an application management screen request has been send to the application management screen request receiving unit 353 of the image forming apparatuses 112 and 132 from a browser or the like of the information processing apparatuses 111 and 131. The application management screen 401 is returned in a format that can be displayed in the display unit 221 of the information processing apparatuses 111 and 131. Additionally, the application management screen 401 is returned in a format that can be displayed by the display unit 211 of the image forming apparatuses 112 and 132 in the case where an application management screen request has been sent to the application management screen request receiving unit 353 of the image forming apparatuses 112 and 132 from a browser or the like running in the image forming apparatuses 112 and 132.

The values of items 402 to 405 displayed in the application management screen are set on the basis of the records in the device license information table. An “application ID” column 402 displays the value in the application ID column of the device information table. An “application name” column 403 displays the value in the application name column of the device information table. An “application version” column 404 displays the value in the application version column of the device information table. A “usable period” column 405 displays information based on the values in the use start date and use end date columns of the device information table. In the case where both the use start date and the use end date are available, the information is displayed in the format “use start date−use end date”, whereas in the case where only the use end date is available, the information is displayed in the format “−use end date”. The server-directed license confirmation button 406 is a button for sending the license update request to the license server 101. The license update request is sent to the license server 101 by the license update request sending unit 352 in the case where the server-directed license confirmation button 406 is pressed. At that time, the value of the application ID in the record for which the server-directed license confirmation button 406 was pressed and a device serial number held in the device license information holding unit 342 are included in the license update request.

Period Extension Application Screen

FIG. 5 illustrates an example of the period extension application screen provided by the license server 101 through the extension application screen request receiving unit 328 and displayed in the information processing apparatus 121. The period extension application screen 501 is a screen for applying to extend a period. The period extension application screen 501 is returned as a response from the license server 101 in the case where the extension application screen request has been sent to the extension application screen request receiving unit 328 of the license server 101 from a browser or the like of the information processing apparatus 121. The period extension application screen 501 is returned in a format that can be displayed in the display unit 221 of the information processing apparatus 121.

A “license access number” entry field 502 is a text field into which a license access number for which the period extension application is to be made is entered. A “device serial number” entry field 503 is a text field into which the device serial number of the image forming apparatus for which the period extension application is to be made is entered. An administrator can know these pieces of information by checking the information processing apparatus, for example.

The period extension application is sent to the license server 101 via the network I/F 226 of the information processing apparatus 121 upon an “apply” button 504 being pressed. At this time, the period extension application includes the values in the license access number entry field 502 and the device serial number entry field 503. The license server 101 receives the period extension application made by the extension application receiving unit 329.

Data Structure of Files

FIGS. 6A to 6D illustrate the data structures of the files. FIG. 6A is a diagram illustrating the data structure of the application file 601; FIG. 6B, of the installation license 611; FIG. 6C, of an extension installation license 621; and FIG. 6D, of the update license 631.

Application File Structure

The application file 601 illustrated in FIG. 6A is an extension program file installed to enable the use of an aftermarket extended function, in addition to the basic functions. The application file 601 holds information corresponding to at least the following items 602 to 605. The application ID 602 is an identifier for uniquely identifying the type of the application file 601. The application name 603 and the application version 604 indicate the name and version of the application file 601, respectively. An executable file 605 is a program that runs on the image forming apparatuses 112 and 132.

Installation License Structure

The installation license for initial setup 611 illustrated in FIG. 6B is issued by the license access number issuance request receiving unit 323 along with the license access number. The installation license 611 holds information corresponding to at least the following items 612 to 615.

The license ID 612 is an identifier that enables the license to be uniquely identified. The application ID 613 is an identifier of the application file 601 that can be installed using that license. The device serial number 614 is the serial number of the image forming apparatuses 112 and 132 in which the file can be installed using that license. The device serial number in the installation license 611 may be a “*”, that is, a wild card indicating that the file can be installed in any image forming apparatus.

The usable number of days 615 is a number of days the license enables the application file 601 to be used for (a usage period). In the case where a value of “5” is held in the usable number of days 615, the application file 601 installed using that license is permitted to be used for five days from the date of installation. In the present embodiment, the usable number of days 615 in the installation license 611 is fixed at a value of “5”, but the installation license 611 may be issued such that the usable number of days is set when the license access number is issued, the product is registered, and so on. The usable period may be specified instead of the usable number of days.

Extension Installation License Structure

The extension installation license 621 for extending the period, illustrated in FIG. 6C, is issued by the extension application receiving unit 329. The extension installation license 621 holds information corresponding to at least the following items 622 to 625.

A license ID 622 is an identifier that enables the license to be uniquely identified. An application ID 623 is an identifier of the application file 601 that can be installed using that license. A device serial number 624 is the serial number of the image forming apparatuses 112 and 132 in which the file can be installed using that license. The device serial number 624 of the extension installation license 621 holds the device serial number included in the period extension application, so that the file can be installed only in the image forming apparatus for which a period extension application has been made.

A usable number of days 625 is a number of days the license can extend the use of the application file 601 for (a usage period). In the case where a value of “3” is held in the usable number of days 625, the application file 601 installed using that license is permitted to be used for an additional three days from the date of installation. In the present embodiment, the usable number of days 625 in the extension installation license 621 is fixed at a value of “3”, but the extension installation license 621 may be issued such that the number of days of the extension is set when the period extension application is made.

Update License Structure

The update license 631 illustrated in FIG. 6D is issued by the usage information registration request receiving unit 324 when the usage information is registered. The update license 631 holds information corresponding to at least the following items 632 to 636. The license ID 632 is an identifier that enables the license to be uniquely identified. The application ID 633 is an identifier of the application file 601 that can be installed using that license. The device serial number 634 is the serial number of the image forming apparatuses 112 and 132 in which the file can be installed using that license. The use start date 635 and the use end date 636 are the dates when the application file 601 can be used and when the use of the application file 601 ends according to that license, respectively.

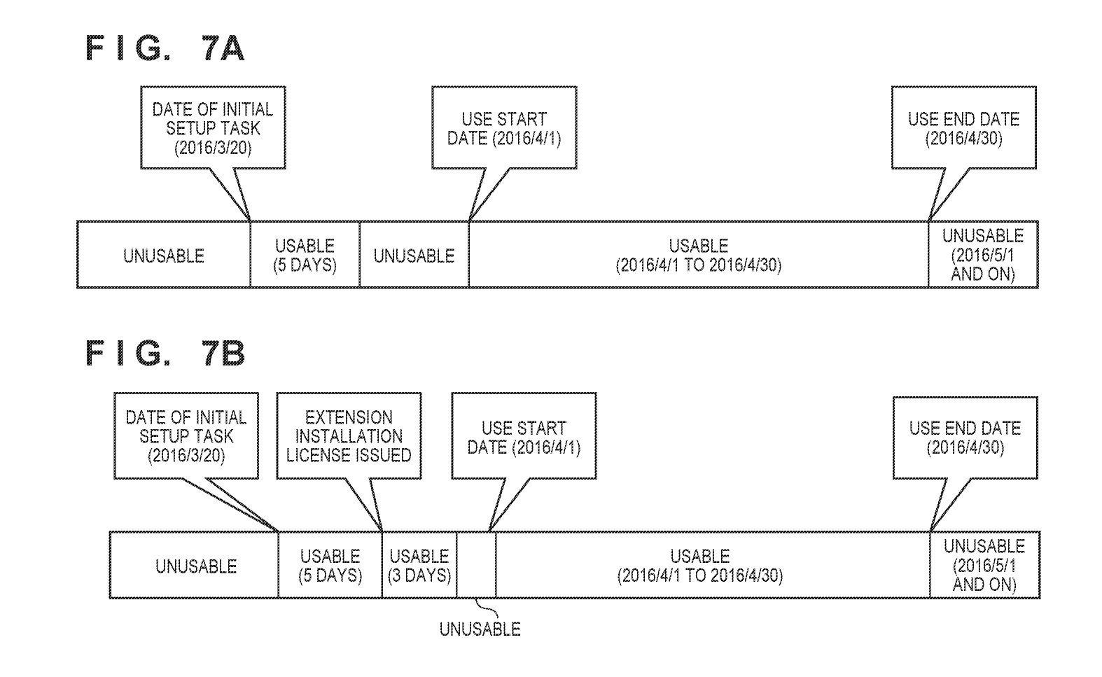

FIGS. 7A and 7B are diagrams illustrating an example of the usable period of an application in the image forming apparatus. FIG. 7A illustrates an example in the case where an update license is acquired after the installation license period has ended, and indicates an application usable period for the case where the following two operations have been carried out.

The first is that the application has been installed in the image forming apparatus using the installation license on Mar. 20, 2016. The second is that usage information indicating a usable period from Apr. 1, 2016 to Apr. 30, 2016 has been registered in the license server 101 between Mar. 21, 2016, and Mar. 25, 2016.

In the case where such operations have been carried out, the application file can be used from Mar. 20, 2016, which is when the installation license is installed, to Mar. 25, 2016. The image forming apparatus acquires an update license in response to a license update request made by the license update request sending unit 352 on Mar. 26, 2016, when the application file can no longer be used. However, because the update license is valid from Apr. 1, 2016, the application file cannot be used from Mar. 26, 2016 to Mar. 31, 2016. The update license enables the application file to be used again from Apr. 1, 2016 to Apr. 30, 2016, and the application file cannot be used from May 1, 2016.

FIG. 7B illustrates an example in the case where an extension installation license is acquired after the installation license period has ended, and indicates an application usable period for the case where the following three operations have been carried out.

The first is that the application has been installed in the image forming apparatus using the installation license on Mar. 20, 2016. The second is that a period extension application has been registered in the license server 101 between Mar. 21, 2016, and Mar. 25, 2016. The third is that usage information indicating a usable period from Apr. 1, 2016 to Apr. 30, 2016 has been registered between Mar. 26, 2016 and Mar. 28, 2016.

In the case where such operations have been carried out, the application file can be used from Mar. 20, 2016, which is when the installation license is installed, to Mar. 25, 2016. On Mar. 26, 2016, when the application file can no longer be used, the image forming apparatus acquires an extension installation license in response to a license update request made by the license update request sending unit 352, and as a result the application file can be used until Mar. 28, 2016. The image forming apparatus then acquires an update license in response to a license update request made by the license update request sending unit 352 on Mar. 29, 2016, when the application file can no longer be used. However, because the update license is valid from Apr. 1, 2016, the application file cannot be used from Mar. 29, 2016 to Mar. 31, 2016. The update license enables the application file to be used again from Apr. 1, 2016 to Apr. 30, 2016, and the application file cannot be used from May 1, 2016.

Application Installation Procedure

FIG. 11 illustrates an overview of the procedures carried out when installing an application and a license in the image forming apparatus. FIG. 11 illustrates the license update request (S1111) as being sent from the image forming apparatus. FIG. 11 also does not illustrate error responses. Furthermore, although the various function modules described above run on various apparatuses, FIG. 11 simply illustrates the functions as being carried out by those apparatuses, and may illustrate such functions in a simpler manner than as described above.

First, the information processing apparatus 121 sends a license access number issuance request to the license server 101. The license server 101 issues a license access number and an installation license in response to the request (S1102), and returns the license access number to the information processing apparatus 121 (S1103). In response to operations made by an administrator, for example, the information processing apparatus 121 sends an installation request to the image forming apparatus along with the license access number (S1104). Having received these items, the image forming apparatus sends an application file acquisition request and a license acquisition request to the license server 101 (S1105). In response to the request, the license server 101 sends an application file along with an already-issued installation license for that application file to the image forming apparatus (S1106). In the image forming apparatus, an administrator or the like carries out operations for installing the application.

Here, in the case where the administrator or the like wishes to extend the installation license, an extension application screen request is sent to the license server 101 from the information processing apparatus 121 (S1107). The license server 101 sends information of the extension application screen (called simply the “extension application screen” here) in response to the request (S1108). When the user enters the necessary information in the screen and instructs the information to be sent, the application for extension is sent to the license server 101 (S1109).

The license server 101 executes the processing illustrated in FIG. 9, which will be described later, in response to the application for extension, and then either issues or does not issue the extension installation license (S1110).

In response to these operations, or upon the validity period of the installation license ending, the image forming apparatus sends a license update request to the license server 101 (S1111). Having received the license update request, the license server 101 executes the processing illustrated in FIG. 10, which will be described later (S1112), and sends the already-issued extension installation license, update license, and so on to the image forming apparatus. Although not illustrated, an update license conforming to contract conditions or the like of the application, for example, is issued by the license server 101 in response to a request from the information processing apparatus 121 or the like. The update license being sent in step S1113 corresponds to this type of case, where an update license has already been issued.

Through this sequence, the installation license is issued, and the extension installation license for extending the usage period provided by the installation license is issued as well. Here, the extension installation license can be installed only in the image forming apparatus for which the application for extension has been made.

Processing of Extension Application Receiving Unit 329 (S1110)

Next, a license processing procedure according to the embodiment will be described with reference to the flowcharts from FIG. 8 on. FIG. 8 is a flowchart illustrating processing executed in the license server 101 when the extension application receiving unit 329 has received a period extension application via the network I/F 226. The period extension application is sent from the information processing apparatus 121 in the sales company network environment 120. The extension application receiving unit 329 issues the extension installation license on the basis of the license access number and the device serial number included in the received period extension application.

In step S801, the extension application receiving unit 329 receives the period extension application.

In step S802, the extension application receiving unit 329 acquires the device serial number from the period extension application received in S801.

In step S803, the extension application receiving unit 329 acquires the license access number from the period extension application received in S801.

In step S804, the extension application receiving unit 329 checks whether or not there is an update license corresponding to the device serial number and the license access number received in S802 and S803. Specifically, the extension application receiving unit 329 checks whether or not a usage information record in which both the device serial number and the license access number match those acquired in S802 and S803 is present in the usage information table. In the case where such a usage information record is determined to be present, that matching record is acquired, and the process moves to S805. In the case where such a usage information record is not present, the process moves to S807.

In step S805, the extension application receiving unit 329 uses the usage information record acquired in S804 to check whether the following condition is met: value in use start date column≦current date≦value in use end date column. In other words, it is determined whether an update license specified by the device serial number and the license access number acquired from the period extension application is valid. In the case where it is determined that the condition is met, the process moves to S806, whereas in the case where it is determined that the condition is not met, the process moves to S807.

In step S806, if the update license is valid, the extension application receiving unit 329 does not issue the extension installation license, and instead returns an error in response to the period extension application.

On the other hand, if the update license is not valid, the extension application receiving unit 329 issues the extension installation license in step S807. Specifically, the extension application receiving unit 329 identifies the product ID from the license access number information table on the basis of the license access number obtained in S803, and furthermore identifies the application ID from the product information table on the basis of the identified product ID. Next, the extension application receiving unit 329 issues a license ID unique to that license. Next, the extension application receiving unit 329 issues an extension installation license holding the identified application ID, the device serial number acquired in S802, the issued license ID, and the usable number of days (3, in this example). The issued extension installation license is stored in the hard disk 224 of the license server 101. An extension installation license that can only be installed in an image forming apparatus for which a period extension application has been made can be issued through this procedure.

In step S808, the extension application receiving unit 329 adds a new record to the extension application information table. The license access number acquired in S803, the device serial number acquired in S802, and the path in which the license ID and extension installation license issued in S807 are located are held in the columns of the added record. Additionally, “not yet acquired” is set in the status column.

In step S809, the extension application receiving unit 329 returns a message indicating that the period extension application has been received to the information processing apparatus that sent the period extension application.

Through the processing illustrated in the flowchart of FIG. 8, the license server 101 can issue an extension installation license to the image forming apparatus that sent the period extension application, and can then stand by for the license update request from the image forming apparatus. Additionally, the license server 101 can avoid issuing an extension license in the case where there is already usage information registered for an update license that currently enables the image forming apparatus for which the period extension application was made to be used. When, for example, an update license enabling use from Apr. 1, 2016 to Apr. 30, 2016, such as illustrated in FIG. 7A, is installed in the image forming apparatus, not issuing the extension license makes it possible to prevent the contract period from being extended by three days from the end date of Apr. 30, 2016 upon a period extension application being made during that contract period. In other words, the extension installation license can be issued only in order to extend the validity period of an installation license for initial setup, and the extension installation license can be prevented from being used to extend the validity period of a normal update license.

Processing of License Update Request Receiving Unit 327 (S1112)

FIG. 9 is a flowchart illustrating processing executed in the license server 101 when the license update request receiving unit 327 has received a license update request via the network I/F 226. The license update request is sent from an apparatus in which the license confirmation button 406 has been pressed, for example, the image forming apparatuses 112 and 132 or an information processing apparatus. The license update request receiving unit 327 returns a license as a response on the basis of the application ID and the device serial number included in the received license update request.

In step S901, the license update request receiving unit 327 receives the license update request.

In step S902, the license update request receiving unit 327 acquires the application ID from the license update request received in step S901.

In step S903, the license update request receiving unit 327 acquires the device serial number from the license update request received in step S901.

In step S904, the license update request receiving unit 327 checks whether or not there is an update license for the application ID and the device serial number acquired in S902 and S903. Specifically, the license update request receiving unit 327 checks whether a usage information record that holds the device serial number acquired in S903 is present. In the case where such a usage information record is present, and the license access number held in the usage information record matches the license access number of the product having the application ID acquired in S902, the license update request receiving unit 327 determines that there is an update license. This determination is made through the following procedure, for example. First, the product ID corresponding to the application ID is acquired by referring to the product information table, and the license access number corresponding to that product ID is acquired from the license access number information table. If the acquired license access number matches the license access number corresponding to the device serial number acquired in S903, it is determined in step S904 that the update license is present. In the case where it is determined that the update license is present, the process moves to S907, whereas in the case where it is determined that the update license is not present, the process moves to S905.

In step S905, because there was no update license, the license update request receiving unit 327 checks whether or not there is an extension installation license that has not yet been acquired. Specifically, the license update request receiving unit 327 checks whether an extension application information record having the device serial number acquired in S903 and a status of “not yet acquired” is present. In the case where such an extension application information record is present, and the license access number held in the extension application information record matches the license access number of the product having the application ID acquired in S902, the license update request receiving unit 327 determines that there is an extension installation license that has not yet been acquired. In the case where it is determined that an extension installation license that has not yet been acquired is present, the process moves to S910, whereas in the case where it is determined that such a license is not present, the process moves to S906.

In step S906, the license update request receiving unit 327 returns an error, indicating that there is no license to be updated, as a response to the license update request, and ends the processing.

In the case where it is determined in S904 that there is a corresponding update license, in step S907, the license update request receiving unit 327 determines whether or not the update license determined to be present is within a usable period. Specifically, the update license is determined to be within a usable period in the case where the use start date and the use end date in the usage information record acquired in S904 meet the following condition: use start date≦current date≦use end date. In the case where the license is within the usable period, the process moves to S909, whereas in the case where the license is not within the usable period, the process moves to S908.

In step S908, the license update request receiving unit 327 checks whether there is an extension installation license for an update license that is not within the usable period. Specifically, the license update request receiving unit 327 checks whether an extension application information record having the device serial number acquired in S903 and a status of “not yet acquired” is present. In the case where such an extension application information record is present, and the license access number held in the extension application information record matches the license access number of the product having the application ID acquired in S902, the license update request receiving unit 327 determines that there is an extension installation license that has not yet been acquired. In the case where an extension installation license that has not yet been acquired is present, the process moves to S910, whereas in the case where such a license is not present, the process moves to S909. In other words, if, in a case such as where the validity period of the update license has not yet ended (FIG. 7B, for example), there is an extension installation license, that license is returned as a response. If there is no extension installation license, the update license is returned.

In step S909, the license update request receiving unit 327 returns the update license acquired in S904 as a response to the license update request, and ends the processing.

In step S910, the license update request receiving unit 327 changes the status of the extension application information record acquired in S905 or S908 to “acquired”.

In step S911, the license update request receiving unit 327 returns the extension installation license acquired in S905 or S908 as a response to the license update request, and ends the processing.

Through the processing illustrated in the flowchart of FIG. 9, when the license server 101 receives a license update request, in the case where there is an update license within a usable period, the license server 101 returns the update license as a response. However, in the case where there is no update license or there is an update license that is not within the usable period, the license server 101 returns an extension installation license. These operations make it possible to continue the initial setup task, even in the case where the validity period of an installation license has ended, by acquiring an extension installation license when both an update license outside the usage period and an extension installation license are present.

Processing of Extension Application Deletion Unit 330

FIG. 10 is a flowchart illustrating processing executed by the extension application deletion unit 330 in the license server 101. The processing illustrated in FIG. 10 may be executed periodically, such as once a day. This is because an extension installation license is deleted in accordance with whether or not the validity period of the update license of the application corresponding to the extension installation license has ended.

In step S1001, the extension application deletion unit 330 acquires a list of the extension application information records held in the extension application information table.

In step S1002, the extension application deletion unit 330 acquires an unprocessed extension application information record from the list of extension application information records acquired in S1001. “Unprocessed” means that the record has not yet undergone the processing illustrated in FIG. 10. For example, the records are taken in any appropriate sequence and processed, which makes it possible to acquire unprocessed records.

In step S1003, the extension application deletion unit 330 acquires the status from the extension application information record acquired in S1002.

In step S1004, the extension application deletion unit 330 checks whether or not the status acquired in S1003 is “not yet acquired”. In the case where the status is “not yet acquired”, the process moves to S1005. In the case where the status is not “not yet acquired”, the record has been processed, and the process returns to S1002.

In step S1005, the extension application deletion unit 330 acquires the device serial number from the extension application information record acquired in S1002.

In step S1006, the extension application deletion unit 330 acquires the license access number from the extension application information record acquired in S1002.

In step S1007, the extension application deletion unit 330 checks whether a usage information record in which both the device serial number and the license access number match those acquired in S1005 and S1006 is present. In the case where such a usage information record is present, that matching record is acquired, and the process moves to S1008. However, in the case where such a usage information record is not present, that record has already been processed, and the process returns to S1002.

In step S1008, the extension application deletion unit 330 checks whether the use start date and use end date in the usage information record acquired in S1007 meet the following condition: use start date≦current date≦use end date. In the case where this condition is met, the process moves to S1009. In the case where this condition is not met, that record has already been processed, and the process returns to S1002.

In step S1009, the extension application deletion unit 330 sets the status in the extension application information record acquired in S1002 to “delete”. That record is thus considered “processed”. In step S1010, the extension application deletion unit 330 checks whether an unprocessed extension application information record is present in the acquired list of extension application information records. In the case where an unprocessed record is present, the process returns to S1002, whereas in the case where no unprocessed records are present, the process ends.

Through the processing illustrated in the flowchart of FIG. 10, in the case where the validity period of an update license has ended before the image forming apparatus has acquired the extension installation license, the extension installation license can be deleted. This makes it possible to avoid a situation in which further use is possible using the extension installation license despite the validity period of the update license having ended. With respect to the extension installation license corresponding to the extension application information record whose status has been set to “delete”, that license file may be deleted in S1009, for example.

According to the embodiment described thus far, in the case where a task for an application has not been completed within the validity period of the installation license of that application, such as when an initial setup task has not ended within a predetermined period, the license server can provide an extension license that extends the period. The extension license is only valid in a specific image forming apparatus, which prevents the license from being used in order to use an application in an apparatus aside from that specific image forming apparatus. Furthermore, the extension license is not issued when an update license based on a contract with a user is valid, and thus the extension license cannot be used to extend the update license without payment. Finally, the extension license for extending the period can be installed automatically when the validity period of the installation license for the image forming apparatus ends, which makes it possible to reduce the burden on the user.

Although the foregoing embodiment describes the application as being installed in an image forming apparatus, the application can also be installed in other types of devices aside from image forming apparatuses.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-097389, filed May 13, 2016, which is hereby incorporated by reference herein in its entirety.

What is claimed is:

1. An information processing apparatus comprising:
a first issuance unit configured to issue an installation license, having a predetermined validity period, for installing a program in a device, and sends the installation license to the device in response to a request from the device;
a second issuance unit configured to issue and save, for the device, an extension installation license that extends the validity period of the installation license by a set period, in response to an extension request; and
a license updating unit configured to send the extension installation license to the device in response to a license update request from the device.

2. The information processing apparatus according to claim 1, further comprising:
a third issuance unit configured to issue and save an update license, having a validity period, for using the program,
wherein in the case where the extension installation license is saved and an update license within the validity period has not been issued, the license updating unit sends the extension installation license to the device in response to the license update request.

3. The information processing apparatus according to claim 2,
wherein in the case where an update license within the validity period has been issued, the second issuance unit sends the update license to the device in response to the license update request.

4. The information processing apparatus according to claim 3, further comprising:
a deletion unit configured to delete the extension installation license in the case where the extension installation license is saved, the license updating unit has sent the update license to the device instead of the extension installation license, and the update license is within the validity period.

5. The information processing apparatus according to claim 4,
wherein the deletion unit attempts to delete the extension installation license periodically.

6. The information processing apparatus according to claim 2,
wherein in the case where an update license that is within the validity period has been issued, the license updating unit does not issue the extension installation license even when the extension request has been made.

7. A programmable device capable of executing a program for which a license has been received, the device comprising:
an acquisition unit configured to acquire, from an information processing apparatus functioning as a license server, an installation license, having a predetermined validity period, for installing a program in the device;
a sending unit configured to send a license update request to the information processing apparatus; and
a receiving unit configured to receive, from the information processing apparatus, an extension installation license that extends the validity period of the installation license by a set period, as a response to the license update request,
wherein the sending unit sends the license update request in the case where the validity period of the installation license has ended.

8. The programmable device according to claim 7, further comprising:
a user interface unit configured to receive an instruction to confirm the license for the installed program,
wherein the sending unit sends the license update request even in the case where the user interface unit has received the instruction to confirm the license for the program.

9. The programmable device according to claim 8,
wherein the user interface unit further displays the installed program and the validity period of the license for the program, and receives an instruction to confirm the license of the program.

10. The programmable device according to claim 7, further comprising:
a unit configured to read an image; and
a unit configured to form an image.

11. A license management system comprising an information processing apparatus and a programmable device capable of executing a program for which a license has been received,
the information processing apparatus including:
a first issuance unit configured to issue an installation license, having a predetermined validity period, for installing a program in a device, and sends the installation license to the device in response to a request from the device;
a second issuance unit configured to issue and save, for the device, an extension installation license that extends the validity period of the installation license by a set period, in response to an extension request; and
a license updating unit configured to send the extension installation license to the device in response to a license update request from the device, and
the programmable device including:
an acquisition unit configured to acquire, from an information processing apparatus functioning as a license server, an installation license, having a predetermined validity period, for installing a program in the device;
a sending unit configured to send a license update request to the information processing apparatus; and
a receiving unit configured to receive, from the information processing apparatus, an extension installation license that extends the validity period of the installation license by a set period, as a response to the license update request,
wherein the sending unit sends the license update request in the case where the validity period of the installation license has ended.

12. A non-transitory computer-readable medium storing a program for causing a computer to function as a license server, the license server comprising:
a first issuance unit configured to issue an installation license, having a predetermined validity period, for installing a program in a device, and sends the installation license to the device in response to a request from the device;
a second issuance unit configured to issue and save, for the device, an extension installation license that extends the validity period of the installation license by a set period, in response to an extension request; and
a license updating unit configured to send the extension installation license to the device in response to a license update request from the device.

13. A non-transitory computer-readable medium storing a program for causing a computer to function as a programmable device capable of executing a program for which a license has been received, the programmable device comprising:
an acquisition unit configured to acquire, from an information processing apparatus functioning as a license server, an installation license, having a predetermined validity period, for installing a program in the device;
a sending unit configured to send a license update request to the information processing apparatus; and
a receiving unit configured to receive, from the information processing apparatus, an extension installation license that extends the validity period of the installation license by a set period, in response to the license update request,
wherein the sending unit sends the license update request in the case where the validity period of the installation license has ended.

14. A license management method that can be used in a license management system including a license server and a programmable device capable of executing a program for which a license has been received, the method comprising:
the license server issuing an installation license, having a predetermined validity period, for installing a program in the programmable device, and sending the installation license to the programmable device in response to a request from the programmable device;
the programmable device acquiring, from the license server, an installation license, having a predetermined validity period, for installing the program;
the license server issuing and saving, for the device, an extension installation license that extends the validity period of the installation license by a set period, in response to an extension request;
the programmable device sending a license update request to the license server;
the license server sending the extension installation license to the device in response to a license update request from the device; and
the programmable device receiving, from the license server, the extension installation license that extends the validity period of the installation license by a set period, as a response to the license update request,
wherein in the sending, the license update request is sent in the case where the validity period of the installation license has ended.
